(19) United States
(12) Patent Application Publication
(10) Pub. No.: US 2024/0077762 A1
(43) Pub. Date: Mar. 7, 2024

(54) DISPLAY

(71) Applicant: BenQ Materials Corporation, Taoyuan (TW)

(72) Inventors: Yu-Wei Tu, Taoyuan (TW); Chih-Wei Lin, Taoyuan (TW); Kuo-Hsuan Yu, Taoyuan (TW)

(73) Assignee: BenQ Materials Corporation, Taoyuan (TW)

(21) Appl. No.: 18/298,337

(22) Filed: Apr. 10, 2023

(30) Foreign Application Priority Data
Sep. 7, 2022 (TW) 111133945

(51) Int. Cl. G02F 1/1335

(52) U.S. Cl. CPC G02F 1/133502; G02F 1/133504; G02F 2201/50

(57) ABSTRACT

A display is disclosed. The display comprises a display panel, and an optical film disposed on a viewing side of the display panel. The optical film has a total haze ranging from 15% to 60%, an inner haze less than or equal to 10%, and a reflectivity satisfying the relationships of 0.35%≤(R_{SCI}-R_{SCE})≤1.50% and R_{SCE}≤1.50%, wherein R_{SCI} is an average reflectivity of diffuse component and specular component, and R_{SCE} is an average reflectivity of diffuse component. By adjusting the total haze, inner haze and reflectivity of the optical film to satisfy the above relationship, the display can have good anti-glare properties, and the contrast ratio of the display will not be reduced too much to avoid the display quality be affected.

### CROSS-REFERENCE TO RELATED APPLICATION

This application claims the priority benefit of Taiwanese Application Serial Number 111133945, filed Sep. 7, 2022, which is incorporated herein by reference.

### FIELD OF THE INVENTION

The present invention is directed to a display and especially to a display with an optical film, wherein the display possesses sufficient anti-glare but the contrast ratio thereof is not reduced for light diffusion.

### BACKGROUND OF THE INVENTION

With the popularization of displays, displays such as liquid crystal displays (LCDs), OLED displays, and micro LED displays are all developing toward high brightness and portability. For more diverse use scenarios such as outdoor environments, the display brightness and image quality of the display under complex environmental light sources are also paid more attention. Conventional displays often improve the display quality by increasing the brightness to increase the contrast ratio of the displayed image, or adding an optical film on the surface of displays to reduce the influence of ambient light. However, under the premise that the usage time cannot be reduced due to excessive power consumption, the display brightness cannot be further increased. Although the optical film added on the surface of displays can reduce interference of the glare and the strong reflection light caused by external ambient light, however, while the optical film destroys the reflection light of ambient light, the intensity and directionality of the display image light will also be reduced after passing through the optical film, so that the contrast ratio of the display is greatly sacrificed.

Generally, the optical film with anti-glare properties can improve the glare problem through haze thereof to diffuse. The haze of the optical film can be divided into surface haze, inner haze and the total haze. It is known that the ratio of the inner haze to the surface haze of the optical film can be adjusted so that the surface haze is relatively low so as not to affect the fineness of the image and the intensity of the image light. Due to the high intensity of external ambient light, when the surface haze is low, it can also make it difficult to cause white cloudiness of the displayed image due to excessive diffusion on the surface of the optical film. However, if the surface haze of the optical film is insufficient, the reflected glare of the external ambient light will not be improved enough. Therefore, the demand for optical film on the surface of the display must have both good anti-glare properties and a low change rate of the contrast ratio, so as to avoid the loss of too much image light intensity, which can only further increase the display brightness and increase energy consumption.

### SUMMARY OF THE INVENTION

The present invention is to provide a display which comprises a display panel and an optical film disposed on a viewing side of the display panel, wherein the optical film has a total haze between 15% and 60%, an inner haze less than or equal to 10%, and a reflectivity satisfying the relationships of 0.35%≤(R_{SCI}-R_{SCE})≤1.50% and R_{SCE}≤1.50%, wherein R_{SCI} is an average reflectivity of diffuse component and specular component (specular component included, SCI), and R_{SCE} is an average reflectivity of diffuse component (specular component excluded, SCE).

In the display of an embodiment of the present invention, the change rate of the contrast ratio of the display satisfies the relationships (CR₁-CR₂)/CR₁≤20%, wherein CR₁ is the contrast ratio of a display with a protective film of a total haze less than 5%, and CR₂ is the contrast ratio of the present display.

In the display of another embodiment of the present invention, the average reflectivity of diffuse component R_{SCE} preferably ranges from 0.80% to 1.50%.

In the display of another embodiment of the present invention, the optical film comprises a substrate, a light diffusing layer disposed on the substrate, and a refractive-index-matching layer disposed on the surface of the light diffusing layer.

In the display of another embodiment of the present invention, the light diffusing layer has a refractive index of n1, the refractive-index-matching layer has a refractive index of n2, and index of n2 is less than index of n1.

In the display of another embodiment of the present invention, the refractive index of n1 of the light diffusion layer ranges from 1.50 to 1.70, and the refractive index of n2 of the refractive-index-matching layer ranges from 1.20 to 1.50.

In the display of another embodiment of the present invention, wherein the thickness of the light diffusion layer ranges from 2 μm to 10 μm.

In the display of another embodiment of the present invention, wherein the thickness of the refractive-index-matching layer ranges from 0.1 μm to 0.3 μm.

The above and other aspects of the invention will become better understood with regard to the following detailed description of the preferred but non-limiting embodiment(s). These and other aspects of the invention will become apparent from the following description of the presently preferred embodiments. The detailed description is merely illustrative of the invention and does not limit the scope of the invention, which is defined by the appended claims and equivalents thereof. As would be obvious to one skilled in the art, many variations and modifications of the invention may be affected without departing from the spirit and scope of the novel concepts of the disclosure.

### BRIEF DESCRIPTION OF DRAWINGS

FIG. 1 is the cross-sectional view of a display of an embodiment of the present invention.

FIG. 2 is the cross-sectional view of a display of another embodiment of the present invention.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details.

It is apparent that departures from specific designs and methods described and shown will suggest themselves to those skilled in the art and may be used without departing from the spirit and scope of the invention. The present invention is not restricted to the particular constructions described and illustrated, but should be construed to cohere with all modifications that may fall within the scope of the appended claims.

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well-known and commonly employed in the art.

The term “(meth)acrylate” used herein refers to acrylate or methacrylate.

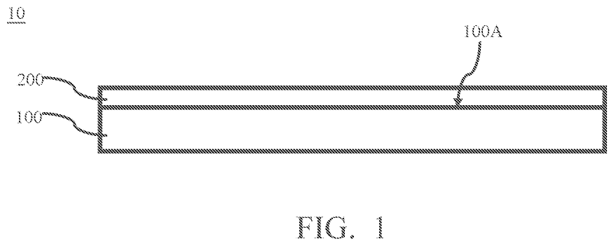

Referring to FIG. 1, one aspect of the present invention is to provide a display 10 which comprises a display panel 100; and an optical film 200 disposed on a viewing side 100A of the display panel 100, wherein the optical film 200 has a total haze ranging from 15% to 60%, an inner haze less than or equal to 10%, and a reflectivity satisfies the relationships of 0.35%≤(R_{SCI}-R_{SCE})≤1.50% and R_{SCE}≤1.50%, wherein R_{SCI} is an average reflectivity of diffuse component and specular component (specular component included, SCI), and R_{SCE} is an average reflectivity of diffuse component (specular component excluded, SCE), and thus, the difference of R_{SCI} and R_{SCE} (R_{SCI}-R_{SCE}) is an average reflectivity of specular component. The display 10 uses the optical film 200 with the total haze ranging from 15% to 60% and the average reflectivity of specular component (R_{SCI}-R_{SCE}) less than or equal to 1.50%, so that the external ambient light can be sufficiently diffused on the surface of the display 10 and without glare caused by strong specular reflection. The average reflectivity of specular component (R_{SCI}-R_{SCE}) of the optical film 200 is more than 0.35% and R_{SCE} is less than or equal to 1.50%, so that the intensity of image light of bright state emitted by the display panel 100 will not be reduced by dispersion due to excessive diffusion. In addition, the inner haze of the optical film 200 is less than or equal to 10%. For the dark state image of the display 10, especially taking the non-self-luminous liquid crystal display as an example, the backlight still emits light in the dark state, and forms a dark state image by absorbing polarized light. Because the optical film 200 generally needs a certain thickness to provide protection and support, so if the inner haze is greater than 10%, the optical path of polarized light which can be diffused and deflected in the optical film 200 is longer, and it is easy to depolarize and pass through the optical film 200, and the level of light leakage in the dark state is thus increased. Because the so-called contrast ratio of the display generally refers to the intensity ratio of the L255 level in the bright state to the LO level in the dark state, no matter what type of display is used, it can maintain a better contrast ratio by avoiding light dispersion in the bright state and/or reducing light leakage in the dark state.

In the display of a preferred embodiment of the present invention, the display panel 100 includes but not limited to liquid crystal display panel (LCD panel), OLED display panel, micro LED display panel and other types of display panels. The change rate of the contrast ratio of the display 10 can be less than or equal to 20% by arranging the optical film 200 on the viewing side of the display panel 100. For self-illuminating displays that do not emit light in the dark state, the contrast ratio can be maintained only by controlling the dispersion of light in the bright state, so the change rate of the contrast ratio is preferably less than or equal to 10%. Herein, the change rate of the contrast ratio refers to the change rate of the contrast ratio between a display using a protective film with a total haze of less than 5% and the display 10 of the present invention having an optical film 200. That is, the measured contrast ratio of the display with a protective film with a total haze of less than 5% is CR₁, and the measured contrast ratio of the display 10 of the present invention is CR₂, and the change rate of the contrast ratio between the two satisfies (CR₁-CR₂)/CR₁≤20%.

In the display of another preferred embodiment of the present invention, the average reflectivity of diffuse component R_{SCE} of the optical film 200 is preferably between 0.80% and 1.50%, so that the optical film 200 can maintain the appearance as a protective film with low total haze, and avoids the excessive diffused light and backscattered light of the external ambient light, which will cause the optical film 200 to become white cloudiness and affect the surface gloss, or make it difficult to control the difference range between R_{SCI} and R_{SCE}, and result in a significant decrease in the contrast ratio of the display.

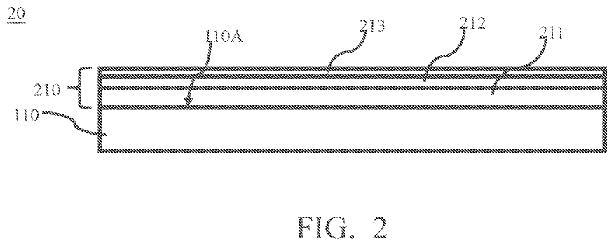

Referring to FIG. 2, it shows a display 20 of another embodiment of the present invention. The optical film 210 on the viewing side 110A of the display panel 110 comprises a substrate 211, a light diffusing layer 212 disposed on the surface of the substrate 211, and a refractive-index-matching layer 213 disposed on the surface of the light diffusing layer 212.

In the display of a preferred embodiment of the present invention, the thickness of the substrate 211 ranges from 10 μm to 150 μm.

In the display of another preferred embodiment of the present invention, the substrate 211 can be a film with good mechanical strength and light transmittance, for example, but not limited to polymethyl methacrylate (PMMA), polyethylene terephthalate (PET), polyethylene naphthalate (PEN), polycarbonate (PC), triacetyl cellulose (TAC), polyimide (PI), polyethylene (PE), polypropylene (PP), polyvinyl alcohol (PVA), polyvinyl chloride (PVC), cyclic olefin polymer (COP) or cyclic olefin copolymer (COC) and the likes.

In the display of another preferred embodiment of the present invention, the light diffusing layer 212 has a refractive index of n1, the refractive-index-matching layer 213 has a refractive index of n2, and the refractive index of n2 is less than the refractive index of n1. By adjusting the distribution of the refractive index, the optical film 210 can achieve a lower total reflectivity of the external ambient light, further improving the display contrast ratio and getting better visual experience of the display 20 under high ambient light. The refractive index of n1 is in the range of 1.50 to 1.70, and the refractive index of n2 is in the range of 1.20 to 1.50.

In the display of a preferred embodiment of the preset invention, the thickness of the light diffusing layer 212 ranges from 2 μm to 10 μm and preferably ranges from 3 μm to 8 μm, sufficiently to provide adequate diffusing light path for ambient light to obtain good anti-glare property. The thickness of the refractive-index-matching layer 213 is less than that of the light diffusing layer 212 and is, for example, between 0.1 μm and 0.3 μm to sufficiently reduce the reflection of the ambient light of visible wavelength.

In the display of another preferred embodiment of the present invention, the light diffusing layer 212 of the optical film 210 comprises a (meth)acrylate composition and a plurality of amorphous silica microparticles and optionally, organic microparticles.

In an optical film of the display of a preferred embodiment of the present invention, the amorphous silica microparticles suitably used in the light diffusion layer 212 have a laser diffraction average particle size of ranging from 3 μm to 10 μm and the BET specific surface area of ranging from 60 to 100 m²/g. The use amount of the amorphous silica microparticles in the light diffusion layer ranges from 6 to 25 parts by weight per hundred parts by weight of the acrylate binder resin

In an optical film of the display of a preferred embodiment of the present invention, the light diffusing layer 212 can optionally add organic microparticles. The organic microparticles in the light diffusion layer 212 are monodispersity, and the average particle size thereof is less than the average particle size of the amorphous silica microparticles. The laser diffraction average particle size of the suitable organic microparticles in the present invention ranges from 2.0 μm to 8.0 μm. In the light diffusion layer 212, the use amount of the organic microparticles is less than 20 parts by weight per hundred parts by weight of the acrylate binder resin.

The organic microparticles suitably used in the light diffusion layer 212 can be polymethyl methacrylate resin microparticles, polystyrene resin microparticles, styrene-methyl methacrylate copolymer microparticles, melamine microparticles, polyethylene resin microparticles, epoxy resin microparticles, polysiloxane resin microparticles, polyvinylidene fluoride resin microparticles or polyvinyl fluoride resin microparticles. The refractivity of the suitable organic microparticles ranges from 1.40 to 1.70.

In an optical film of the display of a preferred embodiment of the present invention, the acrylate binder resin of the light diffusion layer 212 comprises a (meth)acrylate composition and a initiator, wherein the (meth)acrylate composition comprises 35 to 50 parts by weight of the polyurethane (meth)acrylate oligomer with a functionality of 6 to 15, 12 to 20 parts by weight of the (meth)acrylate monomer with a functionality of 3 to 6 and 1.5 to 12 parts by weight of the (meth)acrylate monomer with a functionality of less than 3, wherein the polyurethane (meth)acrylate oligomer with a functionality of 6 to 15 is preferably the aliphatic polyurethane (meth)acrylate oligomer with the molecular weight ranges from 1,000 to 4,500.

In the acrylate binder resin, the suitable (meth)acrylate monomer with a functionality of 3 to 6 preferably can be the (meth)acrylate monomer with the molecular weight less than 800, such as, but not limited to pentaerythritol triacrylate (PETA), dipentaerythritol hexaacrylate (DPHA), dipentaerythritol pentaacrylate (DPPA) or combination thereof. The suitable (meth)acrylate monomer with a functionality of less than 3 can be a (meth)acrylate monomer with a functionality of 1 or 2 and the molecular weight thereof is less than 500, such as, but not limited to 1,6-hexanediol diacrylate (HDDA), cyclic trimethylolpropane formal acrylate (CTFA), 2-phenoxyethyl acrylate (PHEA) or isobornyl acrylate (IBOA) or combinations thereof.

In an optical film of the display of a preferred embodiment of the present invention, the suitable initiator used in the acrylate binder resin of the light diffusing layer 212 can be selected from those commonly used in the related art, such as, but not limited to, acetophenones-based initiator, diphenylketones-based initiator, propiophenones-based initiator, benzophenones-based initiator, bifunctional α-hydroxyketones-based initiator, acylphosphine oxides-based initiator and the like. The above-mentioned initiators can be used alone or in combination.

In an optical film of the display of a preferred embodiment of the present invention, the light diffusing layer 212 can further comprise a leveling agent to provide a good leveling and smoothness of the coated surface. Such as, the fluorine-based, (meth)acrylate-based or organosilicon-based leveling agents can be used in the light diffusion layer 212 of the present invention.

In an optical film of the display of a preferred embodiment of the present invention, the refractive-index-matching layer 213 is disposed on the light diffusing layer 212. The refractive-index-matching layer 213 comprises a binder resin, a plurality of hollow silica nanoparticles, and a leveling agent comprising a perfluoropolyether group-containing (meth)acrylic-modified organosilicone, wherein the average particle size of the hollow silica nanoparticles ranges from 50 nm to 100 nm.

In an optical film of the display of a preferred embodiment of the present invention, the binder resin used in refractive-index-matching layer 213 can be (meth)acrylate resin or the fluoro-and-acrylic-modified polysiloxane resin. The (meth)acrylate resin can be, for example, pentaerythritol tri(meth)acrylate, dipentaerythritol hexa(meth)acrylate, pentaerythritol tetra(meth)acrylate, dipentaerythritol penta(meth)acrylate, trimethylolpropane tri(meth)acrylate, ditrimethylolpropane tetra(meth)acrylate, dipentaerythritol tetra(meth)acrylate or the combination thereof. When the (meth)acrylate resin is used as the binder resin for the refractive-index-matching layer 21, the use amount of the hollow silica nanoparticles in the refractive-index-matching layer 213 ranges from 60 to 130 parts by weight per hundred parts by weight of the (meth)acrylate resin.

In an optical film of the display of a preferred embodiment of the present invention, the fluoro-and-acrylic-modified polysiloxane resin used in the refractive-index-matching layer 213 can be a polysiloxane having a siloxane main chain, a branched chain containing a fluoroalkyl group and a branched chain containing an acrylate functional group. The suitable fluoro-and-acrylic-modified polysiloxane resin can be, but not limited to, for example, commercially available siloxane resin products, such as X-12-2430C manufactured by Shin-Etsu Chemical Co., Ltd., Japan. When the fluoro-and-acrylic-modified polysiloxane resin is used as the binder resin for the refractive-index-matching layer 213, the use amount of the hollow silica nanoparticles in the refractive-index-matching layer 213 ranges from 90 to 350 parts by weight per hundred parts by weight of the fluoro-and-acrylic-modified polysiloxane resin.

In an optical film of the display of a preferred embodiment of the present invention, the refractive-index-matching layer 213 can further comprise a leveling agent. The suitable leveling agent can be a perfluoropolyether group-containing (meth)acrylic-modified organosilicone compound. The suitable leveling agent comprising a perfluoropolyether group-containing (meth)acrylic-modified organosilicone compound can be, but not limited to, for example, commercially available products, such as X-71-1203E, KY-1203, KY-1211 or KY-1207 manufactured by Shin-Etsu Chemical Co., Ltd., Japan. The use amount of the leveling agent varies with the type of binder resin used. When the (meth)acrylate resin is used as the binder resin for the refractive-index-matching layer 213, the use amount of the leveling agent ranges from 5 to 20 parts by weight per hundred parts by weight of the (meth)acrylate resin. When the fluoro-and-acrylic-modified polysiloxane resin is used as the binder resin for the refractive-index-matching layer 213, the use amount of the leveling agent in the refractive-index-matching layer ranges from 1 to 45 parts by weight per hundred parts by weight of the fluoro-and-acrylic-modified polysiloxane resin.

The suitable initiator used in the refractive-index-matching layer 213 of the optical film of the present display can be, but not limited to, for example, commercially available products, such as “Esacure KIP-160”, “Esacure One”, “Omnirad 184”, “Omnirad 907” and “Omnirad TPO” manufactured by IGM Resins B.V., Netherlands, and “TR—PPI-ONE” manufactured by Tronly Enterprise Co., Ltd., Hong Kong.

Another aspect of the present invention is to provide a method for preparing an optical film, which comprises steps of preparing a light diffusing coating solution and coating the solution on a substrate, drying the substrate coated with the light diffusing coating solution, curing the light diffusion coating layer on the substrate by radiation or electron beam for forming a light diffusion layer, preparing a refractive-index-matching coating solution, coating the refractive-index-matching coating solution on the light diffusing layer, drying to remove the solvent and curing by radiation or electron beam for forming a refractive-index-matching layer on the light diffusing layer to obtain an optical film.

The method for preparing the light diffusing coating solution for the optical film of the present display comprises steps of mixing a (meth)acrylate composition comprising a polyurethane (meth)acrylate oligomer with a functionality of 6 to 15, at least one (meth)acrylate monomer with a functionality of 3 to 6, at least one (meth)acrylate monomer with functionality of less than 3, an initiator and adequate solvent(s) and stirred evenly for preparing an acrylate binder resin solution; adding a plurality of amorphous silica microparticles, a leveling agent and an adequate organic solvent into the acrylic binder resin solution and stirring evenly for preparing a light diffusion coating solution. In another embodiment of the present invention, the light diffusing coating solution can optionally add a plurality of organic microparticles.

The refractive-index-matching layer of the optical film of the present display can be prepared by mixing and a binder resin, a plurality of hollow silica nanoparticles, an initiator, a leveling agent and an adequate solvent and evenly stirring of the mixture.

In other embodiments of the present invention, other additives such as antistatic agents, colorants, flame retardants, ultraviolet absorbers, antioxidants, surface modifiers, antimicrobial agent or defoaming agent can be added to the light diffusion coating solution or the refractive-index-matching coating solution as required for providing desired properties.

In the preparation method of the present invention, the suitable solvents can be the organic solvents commonly used in the related art, such as ketones, aliphatic, cycloaliphatic or aromatic hydrocarbons, ethers, esters or alcohols. The (meth)acrylate composition, light diffusion coating solution and the refractive-index-matching coating solution can use one or one more organic solvents. The suitable solvent can be such as, but not limited to acetone, butanone, cyclohexanone, methyl isobutyl ketone, hexane, cyclohexane, dichloromethane, dichloroethane, toluene, xylene, propylene glycol methyl ether, methyl acetate, ethyl acetate, propyl acetate, butyl acetate, n-butanol, isobutanol, isopropanol, diacetone alcohol, propylene glycol methyl ether acetate, cyclohexanol or tetrahydrofuran and the likes.

The aforementioned coating solution can be applied to the substrate surface by any method known in the related art, for example, bar coating, doctor blade coating, dip coating, roll coating, spinning coating, spray coating, slot-die coating and the like.

The present invention will be explained in further detail with reference to the examples. However, the present invention is not limited to these examples.

### REFERENCE EXAMPLE

The Liquid Crystal display device used in this Reference Example is BenQ C32-310 commercially obtained in Taiwan with an anti-glare film having a haze less than 5% as a protective film. This display device was evaluated the contrast ratio CR₁ by measuring the luminance of the brightest state (L255) and the darkest state (LO) and the ratio thereof. The optical properties of the protective film were evaluated in accordance with the measurement described hereinafter. The test results were listed in Table 1.

Contrast measurement: the contrast was measured by the Spectroradiometer (TOPCON SR-3AR, TOPCON TECHNOHOUSE Corp.) to obtain the luminance of the brightest state (L255) and the darkest state (LO) and the ratio thereof.

Haze measurement: The haze was measured according to the test method of JIS K7136 by the NDH-2000 Haze Meter (Nippon Denshoku Corp.).

Inner haze and Surface haze measurement: The protective films were adhered to a triacetyl cellulose (TAC) substrate by a transparent optical adhesive (T40UZ, thickness 40 μm, available from Fujifilm, Japan) to make the uneven surface thereof flat. In this state, the total haze and the inner haze of prepared sample were measured according to the test method of JIS K7136 by the NDH-2000 Haze Meter, and the surface haze could be obtained by deducting the inner haze from the total haze.

Light transmittance measurement: The light transmittance was measured according to the test method of JIS K7361 by the NDH-2000 Haze Meter.

Gloss measurement: The protective film was adhered to a black acrylic plate acting as a display with orthogonal-axes polarizer via a transparent optical adhesive and the gloss thereof was measured according to the test method of JIS Z8741 by the BYK Micro-Gloss gloss meter at viewing angles of 20, 60 and 85 degrees.

Clarity measurement: The protective film was cut into a sample of 5×8 cm², and the sample was measured according to the test method of JIS K7374 by the SUGA ICM-IT image clarity meter, and the sum of the measured values at slits of 0.125 mm, 0.25 mm, 0.50 mm, 1.00 mm and 2.00 mm was the clarity.

Reflectivity measurement: The protective film was adhered to a black acrylic plate acting as a display with orthogonal-axes polarizer and the average reflectivity (R_{SCI}) of diffuse component and specular component (specular component included, SCI) and an average reflectivity (R_{SCE}) of diffuse component (specular component excluded, SCE) of the protective film was measured by the HITACHI U-4150 spectrometer in a wavelength range of 380-780 nm.

Anti-glare evaluation: The protective film removed from the display was adhered to a black acrylic plate via a transparent optical adhesive, and the protective film was illuminated by 2 fluorescent tubes to check the status of reflected by observation. The evaluation criteria of the anti-glare of the protective film were listed as below. The Lv.5 of anti-glare was deemed as “pass”.
Lv.1: Two separate fluorescent tubes could be seen clearly and the straight outlines of tubes was distinguished obviously;
Lv.2: Two separate fluorescent tubes could be seen clearly, but the outlines of tubes were slightly fuzzy;
Lv.3: Two separate fluorescent tubes could be seen, and although the outlines of tubes were fuzzy but the shapes of tubes could be distinguished;
Lv.4: It could be seen that there were 2 fluorescent tubes, but the shapes of tubes could not be distinguished;
Lv.5: It could not be seen that there were 2 fluorescent tubes and the shapes of tubes could not be distinguished.

### EXAMPLE

### Preparation Example 1: Preparation of Acrylate Binder Resin I

42 parts by weight of polyurethane acrylate oligomer (functionality of 6, molecular weight of about 1,600, viscosity of 36,000 cps (at 25° C.), commercially obtained from IGM, Taiwan), 4.5 parts by weight of PETA, 12 parts by weight of DPHA, 3 parts by weight of CTFA, 4 parts by weight of initiator (Chemcure-481, available from Chembridge International Co., Ltd., Taiwan), 24.5 parts by weight of ethyl acetate (EAC) and 10 parts by weight of n-butyl acetate (nBAC) were mixed for 1 hour to obtain an acrylate binder resin I.

### Preparation Example 2: Preparation of Acrylate Binder Resin II

42 parts by weight of polyurethane acrylate oligomer (functionality of 6, molecular weight of about 2,600, viscosity of 62,000 cps (25° C.), commercially obtained from Miwon Specialty Chemical Co., Ltd, Korea), 4.5 parts by weight of PETA, 12 parts by weight of DPHA, 3 parts by weight of IBOA, 4 parts by weight of initiator (Chemcure-481), 24.5 parts by weight of ethyl acetate (EAC) and 10 parts by weight of n-butyl acetate (nBAC) were mixed for 1 hour to obtain an acrylate binder resin II.

### Preparation Example 3: Preparation of Refractive-Index-Matching Coating Solution

35 parts by weight of fluorine-containing acrylate-modified polysiloxane resin (X-12-2430C, available from Shin-Etsu Chemical Co., Ltd., Japan), 2.3 parts by weight of photoinitiator (KIP-160, available from IGM Resin, Netherlands), 21.5 parts by weight of a perfluoropolyether containing (meth)acrylic-modified organosilicone (X-71-1203E, solid content of 20%, solvent: methyl ethyl ketone, available from Shin-Etsu Chemical Co., Ltd., Japan), 186.7 parts by weight of hollow silica nanoparticle dispersion (Thrulya 4320, solid content 20%, average primary particle size of 60 nm, solvent: methyl isobutyl ketone, JGC Catalysts and Chemicals Ltd., Japan), 1823 parts by weight of ethyl acetate (EAC) and 1674 parts by weight of propylene glycol methyl ether acetate (PGMEA) were mixed and stirred for 10 minutes to obtain a refractive-index-matching coating solution.

### Example 1

100 parts by weight of acrylate binder resin I obtained from Preparation Example 1, 11.75 parts by weight of amorphous silica microparticles (Nipsil® SS-50F, average particle size of 2.2 μm, refractive index of 1.45˜1.47, available from Tosoh Silica Corp., Japan), 1.1 parts by weight of dispersing agent (DisperBYK-2150, solid content of 5%, solvents: ethyl acetate and propylene glycol methyl ether acetate, available from BYK-Chemie, Germany), 6.5 parts by weight of polyether-modified acrylate leveling agent (BYK-UV3535, solid content of 10%, solvent: ethyl acetate, available from BYK-Chemie, Germany), 4.5 parts by weight of silica nanoparticles dispersion (NanoBYK-3650, average particle size of 20 nm, solid content 31%, solvent: propylene glycol monomethyl ether acetate/propylene glycol monomethyl ether, commercially obtained from BYK, Germany), 32.5 parts by weight of ethyl acetate (EAC) and 80 parts by weight of n-butyl acetate (nBAC) were mixed and stirred to be uniformly dispersed to obtain a light diffusing coating solution. The obtained light diffusing coating solution was coated on a triacetyl cellulose (TAC) substrate with a thickness of 60 μm. After drying, the coated film was cured by a UV lamp with a radiation dose of 298 mJ/cm² under a nitrogen atmosphere to form a light diffusion layer with a thickness of 5.0 μm on the TAC substrate. Then, the refractive-index-matching coating solution obtained from Preparation Example 3 was coated on the light diffusing layer. The film coated with the refractive-index-matching coating solution was dried in an oven at 80° C. for 2 minutes and cured by a UV lamp with a radiation dose of 350 mJ/cm² under a nitrogen atmosphere to form a refractive-index-matching layer with a thickness of 0.13 μm on the light diffusion layer to obtain an optical film.

### Example 2

100 parts by weight of acrylate binder resin I obtained from Preparation Example 1, 13 parts by weight of amorphous silica microparticles (Nipsil® SS-50F), 1.1 parts by weight of dispersing agent (DisperBYK-2150), 6.5 parts by weight of polyether-modified acrylate leveling agent (BYK-UV3535), 4.5 parts by weight of silica nanoparticles dispersion (NanoBYK-3650), 32.5 parts by weight of ethyl acetate (EAC) and 80 parts by weight of n-butyl acetate (nBAC) were mixed and stirred to be uniformly dispersed to obtain a light diffusing coating solution. The obtained light diffusing coating solution was coated on a TAC substrate with a thickness of 60 μm. After drying, the coated film was cured by a UV lamp with a radiation dose of 298 mJ/cm² under a nitrogen atmosphere to form a light diffusion layer with a thickness of 5.8 μm on the TAC substrate. Then, the refractive-index-matching coating solution obtained from Preparation Example 3 was coated on the light diffusing layer. The film coated with the refractive-index-matching coating solution was dried in an oven at 80° C. for 2 minutes and cured by a UV lamp with a radiation dose of 350 mJ/cm² under a nitrogen atmosphere to form a refractive-index-matching layer with a thickness of 0.13 μm on the light diffusion layer to obtain an optical film.

### Example 3

100 parts by weight of acrylate binder resin I obtained from Preparation Example 1, 8.25 parts by weight of amorphous silica microparticles (Nipsil® SS-50B, average particle size of 4 μm, refractive index of 1.45-1.47, available from Tosoh Silica Corp., Japan), 1.1 parts by weight of dispersing agent (DisperBYK-2150), 6.5 parts by weight of polyether-modified acrylate leveling agent (BYK-UV3535), 4.5 parts by weight of silica nanoparticles dispersion (NanoBYK-3650), 32.5 parts by weight of ethyl acetate (EAC) and 80 parts by weight of n-butyl acetate (nBAC) were mixed and stirred to be uniformly dispersed to make a light diffusing coating solution. The obtained light diffusing coating solution was coated on a triacetyl cellulose (TAC) substrate with a thickness of 60 μm. After drying, the coated film was cured by a UV lamp with a radiation dose of 298 mJ/cm² under a nitrogen atmosphere to form a light diffusion layer with a thickness of 5.6 μm on the TAC substrate. Then, the refractive-index-matching coating solution obtained from Preparation Example 3 was coated on the light diffusing layer. The film coated with the refractive-index-matching coating solution was dried in an oven at 80° C. for 2 minutes and cured by a UV lamp with a radiation dose of 350 mJ/cm² under a nitrogen atmosphere to form a refractive-index-matching layer with a thickness of 0.13 μm on the light diffusion layer to obtain an optical film.

### Example 4

100 parts by weight of acrylate binder resin I obtained from Preparation Example 1, 11 parts by weight of amorphous silica microparticles (Nipsil© SS-50B), 1.1 parts by weight of dispersing agent (DisperBYK-2150), 6.5 parts by weight of polyether-modified acrylate leveling agent (BYK-UV3535), 4.5 parts by weight of silica nanoparticles dispersion (NanoBYK-3650), 32.5 parts by weight of ethyl acetate (EAC) and 80 parts by weight of n-butyl acetate (nBAC) were mixed and stirred to be uniformly dispersed to make a light diffusing coating solution. The obtained light diffusing coating solution was coated on a triacetyl cellulose (TAC) substrate with a thickness of 60 μm. After drying, the coated film was cured by a UV lamp with a radiation dose of 298 mJ/cm² under a nitrogen atmosphere to form a light diffusion layer with a thickness of 6.6 μm on the TAC substrate. Then, the refractive-index-matching coating solution obtained from Preparation Example 3 was coated on the light diffusing layer. The film coated with the refractive-index-matching coating solution was dried in an oven at 80° C. for 2 minutes and cured by a UV lamp with a radiation dose of 350 mJ/cm² under a nitrogen atmosphere to form a refractive-index-matching layer with a thickness of 0.13 μm on the light diffusion layer to obtain an optical film.

### COMPARATIVE EXAMPLE

### Comparative Example 1

100 parts by weight of acrylate binder resin I obtained from Preparation Example 1, 13 parts by weight of spherical silica microparticles (SUNSPHERE® H-31, average particle size of 3.0 μm, refractive index of 1.45, available from AGC Si-Tech Co., Ltd., Japan), 1.1 parts by weight of dispersing agent (DisperBYK-2150), 6.5 parts by weight of polyether-modified acrylate leveling agent (BYK-UV3535), 4.5 parts by weight of silica nanoparticles dispersion (NanoBYK-3650), 32.5 parts by weight of ethyl acetate (EAC) and 80 parts by weight of n-butyl acetate (nBAC) were mixed and stirred to be uniformly dispersed to obtain a light diffusing coating solution. The obtained light diffusing coating solution was coated on a triacetyl cellulose (TAC) substrate with a thickness of 60 μm. After drying, the coated film was cured by a UV lamp with a radiation dose of 298 mJ/cm² under a nitrogen atmosphere to form a light diffusion layer with a thickness of 5.8 μm on the TAC substrate. Then, the refractive-index-matching coating solution obtained from Preparation Example 3 was coated on the light diffusing layer. The film coated with the refractive-index-matching coating solution was dried in an oven at 80° C. for 2 minutes and cured by a UV lamp with a radiation dose of 350 mJ/cm² under a nitrogen atmosphere to form a refractive-index-matching layer with a thickness of 0.13 μm on the light diffusion layer to obtain an optical film.

### Comparative Example 2

100 parts by weight of acrylate binder resin I obtained from Preparation Example 1, 10 parts by weight of polystyrene microparticles (XX-401K, average particle size of 3 μm, refractive index of 1.59, available from Sekisui Kasei Co., Ltd, Japan), 2.4 parts by weight of amorphous silica microparticles (Nipsil® SS-50B), 1.1 parts by weight of dispersing agent (DisperBYK-2150), 6.5 parts by weight of polyether-modified acrylate leveling agent (BYK-UV3535), 2.6 parts by weight of silica nanoparticles dispersion (NanoBYK-3650), 32.5 parts by weight of ethyl acetate (EAC) and 80 parts by weight of n-butyl acetate (nBAC) were mixed and stirred to be uniformly dispersed to make a light diffusing coating solution. The obtained light diffusing coating solution was coated on a triacetyl cellulose (TAC) substrate with a thickness of 60 μm. After drying, the coated film was cured by a UV lamp with a radiation dose of 298 mJ/cm² under a nitrogen atmosphere to form a light diffusion layer with a thickness of 5.2 μm on the TAC substrate. Then, the refractive-index-matching coating solution obtained from Preparation Example 3 was coated on the light diffusing layer. The film coated with the refractive-index-matching coating solution was dried in an oven at 80° C. for 2 minutes and cured by a UV lamp with a radiation dose of 350 mJ/cm² under a nitrogen atmosphere to form a refractive-index-matching layer with a thickness of 0.13 μm on the light diffusion layer to obtain an optical film.

### Comparative Example 3

100 parts by weight of acrylate binder resin II obtained from Preparation Example 2, 16.5 parts by weight of polystyrene microparticles (XX-40IK), 5 parts by weight of amorphous silica microparticles (Nipsil® SS-50B), 6.5 weight parts of polyether-modified polydimethylsiloxane leveling agent (BYK-333, solid content 10%, solvent: n-butyl acetate, commercially obtained from BYK, Germany), 1.1 parts by weight of dispersing agent (DisperBYK-2150), 45 parts by weight of ethyl acetate (EAC) and 80 parts by weight of n-butyl acetate (nBAC) were mixed and stirred to be uniformly dispersed to make a light diffusing coating solution. The obtained light diffusing coating solution was coated on a 60 μm triacetyl cellulose (TAC) substrate. After drying, the coated film was cured by a UV lamp with a radiation dose of 298 mJ/cm² under a nitrogen atmosphere to form a light diffusion layer with a thickness of 6.8 μm on the TAC substrate. Then, the refractive-index-matching coating solution obtained from Preparation Example 3 was coated on the light diffusing layer. The film coated with the refractive-index-matching coating solution was dried in 80° C. oven for 2 minutes and cured by a UV lamp with a radiation dose of 350 mJ/cm² under a nitrogen atmosphere to form a refractive-index-matching layer with a thickness of 0.13 μm on the light diffusion layer to obtain an optical film.

The optical properties of the optical films obtained from Examples 1 to 4 and Comparative Examples 1 to 3 were evaluated as measurements for the protective film in the Reference Example. The protective film originally used in Liquid Crystal display of Reference Example was removed and then the optical films obtained from Examples 1 to 4 and Comparative Examples 1 to 3 were respectively adhered to the liquid crystal display to measure the contrast in accordance with the contrast measurement described in Reference Example and to calculate the contrast ratio CR₂. The change rate of contrast ratio was calculated by (CR₁-CR₂)/CR₁. The measured results were listed in Table 1.

TABLE 1
The optical properties of Reference Example, Examples 1 to 4 and Comparative Examples 1 to 3

| | | Example | | | | | | | |
|---|---|---|---|---|---|---|---|---|---|
| | | Reference | Example | Example | Example | Example | Comparative | Comparative | Comparative |
| | | Example | 1 | 2 | 3 | 4 | Example 1 | Example 2 | Example 3 |
| Light | | 91.9 | 92.6 | 92.6 | 92.9 | 92.9 | 92.1 | 94.5 | 95.2 |
| transmittance (%) | | | | | | | | | |
| Total haze (%) | | 3.1 | 18.9 | 32.5 | 42.0 | 54.9 | 39.1 | 42.5 | 71.9 |
| inner haze (%) | | 1.5 | 1.8 | 2.1 | 5.4 | 3.6 | 15.9 | 35.6 | 43.8 |
| Surface haze (%) | | 1.6 | 17.1 | 30.4 | 36.6 | 51.3 | 23.3 | 6.9 | 28.0 |
| Gloss | 20° | 45.1 | 1.8 | 0.4 | 0.6 | 0.6 | 0.8 | 5.1 | 0.2 |
| | 60° | 82.2 | 20.0 | 8.8 | 8.4 | 4.4 | 8.2 | 30.3 | 5.6 |
| | 85° | 98.4 | 72.8 | 61.6 | 34.7 | 23.8 | 30.9 | 71.2 | 36.6 |

| | | | | | | | | |
|---|---|---|---|---|---|---|---|---|
| Clarity (total) | 451.9 | 113.1 | 81.6 | 15.1 | 28.1 | 19.0 | 76.9 | 16.3 |
| R_{SCI}, % | 4.34 | 1.83 | 1.91 | 1.88 | 1.79 | 2.51 | 1.86 | 1.77 |
| R_{SCE}, % | 0.25 | 0.89 | 1.46 | 1.36 | 1.40 | 1.62 | 0.41 | 1.71 |
| (R_{SCI} − R_{SCE}) % | 4.09 | 0.94 | 0.45 | 0.52 | 0.39 | 0.89 | 1.45 | 0.06 |
| L255 (nits) | 190.6 | 193.6 | 190.5 | 192.2 | 200.9 | 190.6 | 189.1 | 184.2 |
| L0 (nits) | 0.02445 | 0.02443 | 0.02593 | 0.02630 | 0.03105 | 0.03521 | 0.03196 | 0.03992 |
| contrast ratio | 7795 | 7925.6 | 7347.2 | 7306.7 | 6469.7 | 5414.0 | 5916.2 | 4613.8 |
| Change rate of | — | −1.6% | 5.7% | 6.2% | 17.0% | 30.5% | 24.1% | 40.8% |
| contrast ratio (%) | | | | | | | | |
| Anti-Glare | Lv. 2 | Lv. 5 | Lv. 5 | Lv. 5 | Lv. 5 | Lv. 5 | Lv. 4 | Lv. 5 |

As the measurement data shown in Table 1, it can be seen that when the total haze is greater than 15%, either the optical films of Examples 1-4 or Comparative Examples 1-3 can obtain better anti-glare property than the protective film with a total haze of 3.1% in the Reference Example. However, only the optical films of Examples 1-4 whose inner haze is less than or equal to 10% can obtain less light leakage effect in LO level of the dark state. When the reflectivities satisfy the relationships of 0.35%≤(R_{SCI}-R_{SCE})≤1.50% and R_{SCE}≤1.50%, on the premise of that the optical films can have good anti-glare property, their L255 level illuminances of bright state are not easy to be reduced due to excessive diffuse light splitting, so better change rates of the contrast ratio than that of the Reference Example can be obtained. Even in LCD of non-active light-emitting type display panel, which tends to reduce contrast ratio due to light leakage in the dark state, the change rate of the contrast ratio can be less than 20%, without affecting the display quality of the display.

Although particular embodiments have been shown and described, it should be understood that the above discussion is not intended to limit the present invention to these embodiments. Persons skilled in the art will understand that various changes and modifications may be made without departing from the scope of the present invention as literally and equivalently covered by the following claims.

What is claimed is:

1. A display, comprising:
a display panel; and
an optical film disposed on a viewing side of the display panel;
wherein the optical film has a total haze ranges from 15% to 60%, an inner haze less than or equal to 10%, and a reflectivity satisfying the relationships of 0.35%≤(R_{SCI}-R_{SCE})≤1.50% and R_{SCE}≤1.50%, wherein R_{SCI} is an average reflectivity of diffuse component and specular component, and R_{SCE} is an average reflectivity of diffuse component.

2. The display as claimed in claim 1, wherein the display has a change rate of the contrast ratio satisfying the relationships (CR₁-CR₂)/CR₁≤20%, wherein CR₁ is a contrast ratio of a display with a protective film having a haze less than 5%, and CR₂ is a contrast ratio of the display.

3. The display as claimed in claim 1, wherein the average reflectivity of diffuse component R_{SCE} ranges from 0.80% to 1.50%.

4. The display as claimed in claim 1, wherein the optical film comprises a substrate, a light diffusing layer disposed on the substrate, and a refractive-index-matching layer disposed on the light diffusing layer.

5. The display as claimed in claim 4, wherein the substrate has a thickness ranges from 10 μm to 150 μm.

6. The display as claimed in claim 4, wherein the substrate is selected from one of group consisting of polymethyl methacrylate (PMMA), polyethylene terephthalate (PET), polyethylene naphthalate (PEN), polycarbonate (PC), triacetyl cellulose (TAC), polyimide (PI), polyethylene (PE), polypropylene (PP), polyvinyl alcohol (PVA), polyvinyl chloride (PVC), cyclic olefin polymer (COP) and cyclic olefin copolymer (COC).

7. The display as claimed in claim 4, wherein the light diffusing layer has a refractive index of n1, the refractive-index-matching layer has a refractive index of n2, and index of n2 is less than index of n1.

8. The display as claimed in claim 7, wherein the refractive index of n1 ranges from 1.50 to 1.70, and the refractive index of n2 ranges from 1.20 to 1.50.

9. The display as claimed in claim 4, wherein the light diffusion layer has a thickness ranges from 2 μm to 10 μm.

10. The display as claimed in claim 4, wherein the refractive-index-matching layer has a thickness ranges from 0.1 μm to 0.3 μm.
